(19) United States
(12) Patent Application Publication
(10) Pub. No.: US 2013/0317916 A1
(43) Pub. Date: Nov. 28, 2013

(54) LOCATION BASED TECHNOLOGY FOR SMART SHOPPING SERVICES

(71) Applicants: Praveen Gopalakrishnan, Beaverton, OR (US); Richard Roberts, Hillsboro, OR (US); Somya Rathi, Hillsboro, OR (US); Victor Lortz, Beaverton, OR (US)

(72) Inventors: Praveen Gopalakrishnan, Beaverton, OR (US); Richard Roberts, Hillsboro, OR (US); Somya Rathi, Hillsboro, OR (US); Victor Lortz, Beaverton, OR (US)

(73) Assignee: Intel Corporation, Santa Clara, CA (US)

(21) Appl. No.: 13/976,026

(22) PCT Filed: Dec. 29, 2011
(86) PCT No.: PCT/US2011/067749

§ 371 Date: Jun. 25, 2013

(51) Int. Cl. G06Q 30/02

(52) U.S. Cl. CPC G06Q 30/0261
USPC 705/14.66; 705/26.1; 705/26.61

(57) ABSTRACT

A method can include a mobile device, of a user determining location information corresponding to the mobile device within an establishment and communicating with a smart shopping infrastructure. The communicating may include providing the smart shopping infrastructure with the location information. The method can further include cross-referencing the location information with inventory information to determine a first location within the establishment where the mobile device is currently situated, and providing the mobile device with at least one smart shopping service based at least in part on the cross-referencing.

### TECHNICAL FIELD

The disclosed technology relates generally to smart shopping services and, more particularly, to smart shopping services that incorporate a user's location to better enhance the user's shopping experience.

### BACKGROUND

Many buying decisions tend to be made inside a store as users search for or casually browse various types of products on the shelves. One powerful tool for influencing a shopper's buying decisions is to target certain content, such as an advertisement or informational alert, pertaining to specific items that are in the shopper's immediate proximity and, thus, also close to the shopper's mobile device. Another technique is to develop an understanding of a shopper's behavior based on the amount of time he or she spends near particular products as well as content choices he or she makes on the mobile device. Location awareness and shopper context awareness may be combined to create highly targeted content that results in superior shopper engagement and influencing of buying decisions.

However, the key to providing such smart shopping experiences is to gather accurate shopper location, e.g., find out which product(s) the shopper is near at an given time. Existing wireless technologies that estimate location are either unavailable indoors, e.g., GPS or cellular to some extent, or have poor accuracy, e.g., WiFi and cellular, to enable such an experience. For example, while WiFi is a commonly-used indoor location tracking technology, WiFi location accuracy is limited to a few meters, e.g., no more than approximately 2.5 meters. Such accuracy may be adequate for room-level tracking but is not adequate for providing optimized and complete smart shopping services to users.

Another technology that can be used indoors is near field communication (NEC), e.g., radio communication. However, NFC technologies tend to have a very short range, usually on the order of 10 centimeters or less, which essentially means that the user must almost be in physical contact with the source in order to recover any meaningful information with regard to the source. Such a limitation would effectively render NFC incapable of being successfully implemented in a smart shopping service as described above.

Thus, there remains a need for improved smart shopping services provided to users that are based at least in part on the user's location within an establishment.

### BRIEF DESCRIPTION OF THE DRAWINGS

Embodiments of the disclosed technology are illustrated by way of example, and not by way of limitation, in the drawings and in which like reference numerals refer to similar elements.

FIG. 1 is a block diagram illustrating an example of a smart shopping service system in accordance with embodiments of the disclosed technology.

FIG. 2 is a block diagram illustrating an example of various smart shopping services and different types of inputs thereto in accordance with embodiments of the disclosed technology.

FIG. 3 is a flowchart illustrating an example of a machine controlled method of providing one or more smart shopping services in accordance with certain embodiments of the disclosed technology.

FIG. 4 illustrates an example of a system in which certain aspects of the disclosed technology may be implemented.

### DETAILED DESCRIPTION

Embodiments of the disclosed technology may be implemented in virtually any type of indoor location or establishment, e.g., a large retail store, that has a number of lighting sources, e.g., lamps or overhead lighting. In certain embodiments, each user, e.g., shopper, within the establishment, e.g., store, has his or her own mobile device that can be either their own personal smartphone, tablet device, or other handheld electronic device, or an establishment-owned portable device, e.g., a tablet computing device, that may be attached to the shopping cart. For example, shoppers may each carry their own mobile device with them as they travel around a store shopping.

Certain embodiments of the disclosed technology include highly accurate indoor location tracking technology using visible light communication (VLC) location beacon messages. In terms of physical properties such as range and directivity, VLC characteristics are favorable in terms of delivering indoor location based content with very high accuracy. Such location information can be used for or in connection with discovering a number of useful parameters such as user dwell-times and trajectory. Communication with a mobile device over a wireless technology other than VLC may be achieved by tagging VLC location-related information to messages.

By combining accurate location information with a shopper interaction profile and/or a shopper personal profile, for example, smart shopping services using any or all the VLC location-related information may be realized. Certain embodiments include the delivering of content to a user that is immediately relevant to the user, e.g., content that translates typically to items that are within the user's and, thus, his or her mobile device's immediate proximity. Such content may be delivered to the user's mobile device as the user walks by specific items in a store, for example. VLC location precision can be controlled by deploying an appropriate number of sources and being highly directional in order to deliver high accuracy location information to be used by smart shopping services.

Certain implementations may include methods for accurately estimating the location, movement trajectory, dwell time(s), etc. of a user by way of monitoring the user's mobile device in an indoor setting, such as a retail store or shopping mall. A number of smart shopping services can be provided once such accurate location information is known, e.g., discovered or determined. For example, the combination of information pertaining to where a user is inside of a store, e.g., near certain products in a retail store, with information pertaining to a user's response to and/or interest in certain products, advertisements, etc. can be used to influence the user's in-store buying decisions in real-time. Customer response, interest, and interaction may thus be tied with context and location to offer a number of smart shopping services combining such information.

### Accurate Location Tracking Using VLC Technology

The lighting industry has been undergoing a major technological shift toward Light Emitting Diode (LED)-based lighting, due primarily to their superior lifetimes and energy efficiency compared to current lighting technology. LEDs have a modulation bandwidth that can be used to transmit information without any noticeable effects to the lighting function. Such information will be referred to herein as Visible Light Communication (VLC). Thus, LEDs can serve dual purposes of lighting and communication. Furthermore, VLC is ideally suited for providing location information due to its highly directional nature, which comes from having highly directional antennas, e.g., via optics, due to the extremely short wavelength of VLC.

In certain embodiments, each VLC source may transmit a unique ID announcing its fixed location, referred to herein as a location beacon. A shopper's mobile device can be equipped with a VLC receiver such as a photo-diode or photo-sensor array. VLC-enabled light sources may be placed throughout, the store and, as the shopper moves about the store, the VLC-enabled mobile device may receive one or more location beacons that may serve to identify where the user's mobile device is.

The granularity of user location estimation can be controlled by having a sufficient number of VLC-enabled light sources, particularly as compared to WiFi. If the user's mobile device receives multiple location beacon messages, it can use one of a number of techniques to resolve the location. For example, the mobile device can take a simple average of the different locations or a weighted average based on signal strength indicators, or use the angle of location beacon arrival information to determine the location.

In certain embodiments, it is possible to know the location of users' mobile devices and also to communicate with them using an appropriate wireless technology, e.g., WiFi. To enable this, a special packet can be constructed that combines location-related information gathered via VLC with the unique address/identifier of the mobile device. For example, location based content may be enabled from the infrastructure or other mobile devices to be delivered over WiFi, in which case the mobile device can tag its WiFi MAC address or local IP address along with the location information gathered via VLC. This may enable other devices/infrastructure to know the mobile device location and communicate with the mobile device using an appropriate wireless technology, thus complementing the VLC location tracking capability with the communications capability of virtually any other wireless technology.

### Combining Location Information With Interaction and Personal Profiles

Once a user's location information becomes known, other attributes such as the user's dwell time(s), e.g., how long he or she stayed at a certain location within the store, and trajectory, e.g., how the user was moving and to where, may be inferred therefrom. A large number of smart shopping services may use and/or rely on such location-based information. For example, information about one or more products in the immediate vicinity of the user or user's device may be delivered onto the screen of the mobile device.

The user may choose to interact with the smart shopping service(s) to find out more information about a particular product, for example. Certain embodiments include a user interaction profile, which may include information pertaining to which product(s) he or she chose to find out more about, how much time he or she spent in a specific location, etc. A user interaction profile can have information that is very valuable information in inferring the shopper's personal interests. Combining the precise user location with the user's specific interaction profile can be a very rich source of information that can be used to deliver targeted content directly to the user's mobile device.

In certain implementations of the disclosed technology, the user's location and context information may be fed back to the smart shopping infrastructure wirelessly, e.g., via WiFi or VLC. The smart shopping infrastructure may use this information to deliver real-time content to the mobile device or to display appropriate shopper-specific content on fixed digital signage screens within the store as he or she walks up to each one.

In certain implementations, a user can either manually or automatically, e.g. via VLC, NFC, or WiFi, share his or her shopping profile information and/or personal information from their personal device, e.g., smartphone. As used herein, a user's shopping profile includes information generally pertaining to the user's general shopping interests, shopping list, etc., and personal information refers to name, sex, age, and other objective descriptors. Such information may be used in connection with the accurate location information, the user's interaction profile, and any previous shopping history to deliver powerful targeted content.

### Smart Shopping Services

A number of smart shopping services in accordance with the disclosed technology may be based on accurate location information provided by VLC technology, for example, as well as context provided by way of shopper interaction information. In some embodiments, such smart shopping services may also rely on sensors deployed by the user's mobile device itself. Described below are some of the many smart shopping services that may be implemented in a number of embodiments.

In certain embodiments, precise location information, shopper interaction information, personal profiles, or any combination thereof may be used to deliver targeted content to the user's mobile device and/or fixed digital signage. Such targeted content may include an advertisement, shopping or product-specific information, or special promotions relevant to one or more specific items or products situated in the vicinity of the shopper.

Certain implementations may include guiding the shopper inside the store to particular item or service. For example, the user's mobile device can act as an indoor global positioning system (GPS) to help guide the user to the frozen meals section in a grocery store. In certain embodiments, the framework may be used to locate and/or track people by way of locating/tracking their mobile devices. For example, members of a certain group inside a large indoor theme park may have their mobile devices located/tracked so as to keep the leader(s) informed as to the members' whereabouts within the theme park.

Certain implementations of the disclosed technology may include an inventory supply service. In such embodiments, the user may be a store or warehouse employee. As the employee places or re-stocks certain inventory, for example, the user's VLC-enabled mobile device can automatically mark the location of the item for the user. This can be used for automatically re-stocking inventory in future. For example, an automatic device, e.g., robot, may be programmed to put items in a specific location when it determined that a re-stocking is required or when it instructed to do so.

In certain embodiments, offline shopper data analytics concerning shopper dwell times, trajectory, interaction context, or any combination thereof may be used for any of a number of services. For example, a store may use it to determine the placement of certain products and also to provide an appropriate service based on where customers are situated within the store.

### Example Implementations of the Disclosed Technology

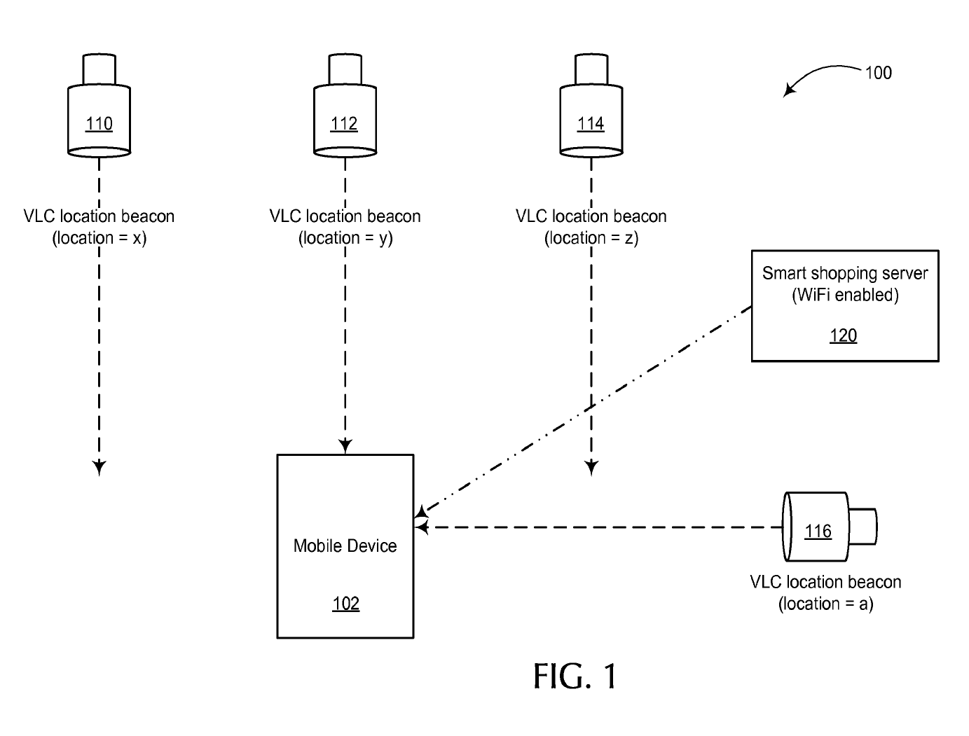

FIG. 1 is a block diagram illustrating an example of a smart shopping service system 100 in accordance with embodiments of the disclosed technology. The system 100 includes multiple VLC-modulated sources 110-116 that are stationed within an establishment, e.g., a store, and each configured to send a location beacon containing the location of the corresponding VLC source. Three of the VLC sources, 110-114, are implemented as overhead lights such that the transmitted light emanates downward onto the users, e.g., customers or shoppers in a store, as well as each user's mobile device 102. In certain embodiments, a horizontal VLC beacon 116 may be implemented for even greater precision with regard to a user's location within the store. In the example, a smart shopping server 120 may communicate with the mobile device 102 over a wireless communication channel, e.g., using WiFi.

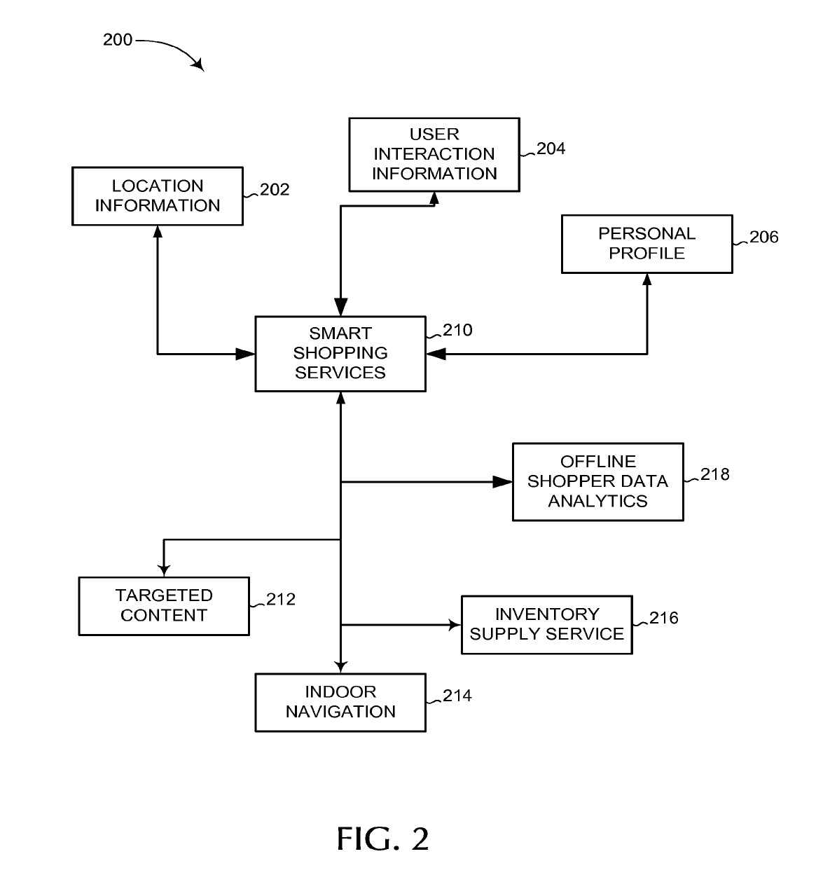

FIG. 2 is a block diagram illustrating an example 200 of various smart shopping services 212-218 and different types of inputs 202-206 thereto in accordance with embodiments of the disclosed technology. In the example, user/device location information 202, user interaction information 204, and a user personal profile 206 may serve as inputs to any of a number of smart shopping services 210, such as targeted content 212, indoor navigation 214, inventory supply service 216, and offline shopper data analytics 218. In certain examples, only some of the inputs 202-206 are used; in other examples, all of the inputs 202-206 are relied upon by the smart shopping services 210.

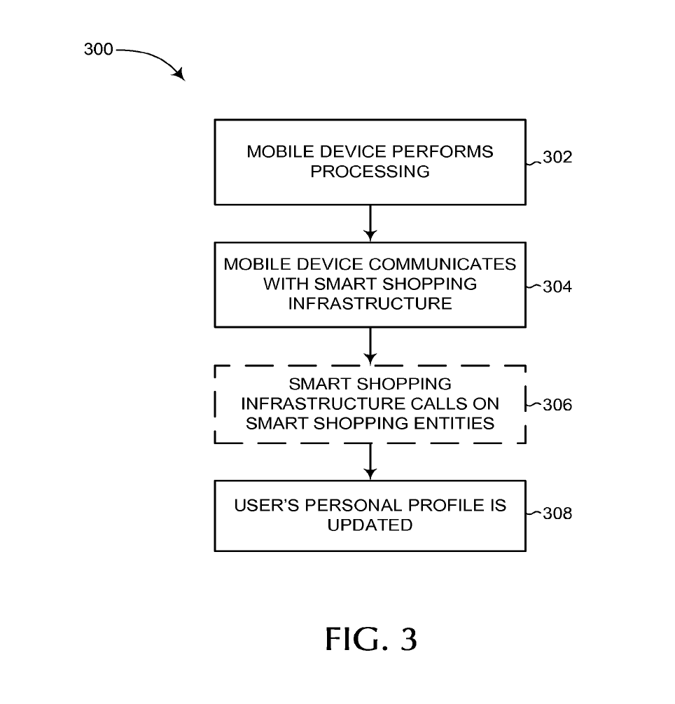

FIG. 3 is a flowchart illustrating an example of a machine controlled method of providing one or more smart shopping services in accordance with certain embodiments of the disclosed technology. At 302, processing within a user's mobile device occurs. Such processing may include converting location information into context relevant content. For example, if the user is standing in front of the juice selection in a supermarket, the mobile device may generate/determine information regarding brand, price, and promotion information as such pertains to the juice in front of the user. In certain embodiments, the mobile device tracks the user's responses along with his or her dwell times at certain locations within the store, e.g., to further infer information concerning the shopper's profile and interests.

Step 304 involves communication between the mobile device and a smart shopping backend infrastructure, which may include a smart shopping server or other device. Such communication may take place using WiFi technology, for example. The mobile device can provide user-specific information such as the current location of the user/device, which the infrastructure may use to further define or develop the user's shopper profile. Further, such infrastructure can deliver location-based content to the device.

Step 306 illustrates an optional extension in which the smart shopping infrastructure is tied to other smart shopping entities within the store such as a digital sign. For example, as the user walks by the digital sign, the smart shopping infrastructure may cause the sign to display content that it determines to be at least potentially relevant to the user.

At 308, the user's personal profile is updated by the user's mobile device, the smart shopping infrastructure, or both. For example, the user's personal profile may be updated at the end of each visit to the establishment, after a certain period of time has passed, after a dwell time has exceeded some predefined threshold, etc. The user's profile may be stored on his or mobile device, remotely, e.g., on a smart shopping server or database, or some combination thereof.

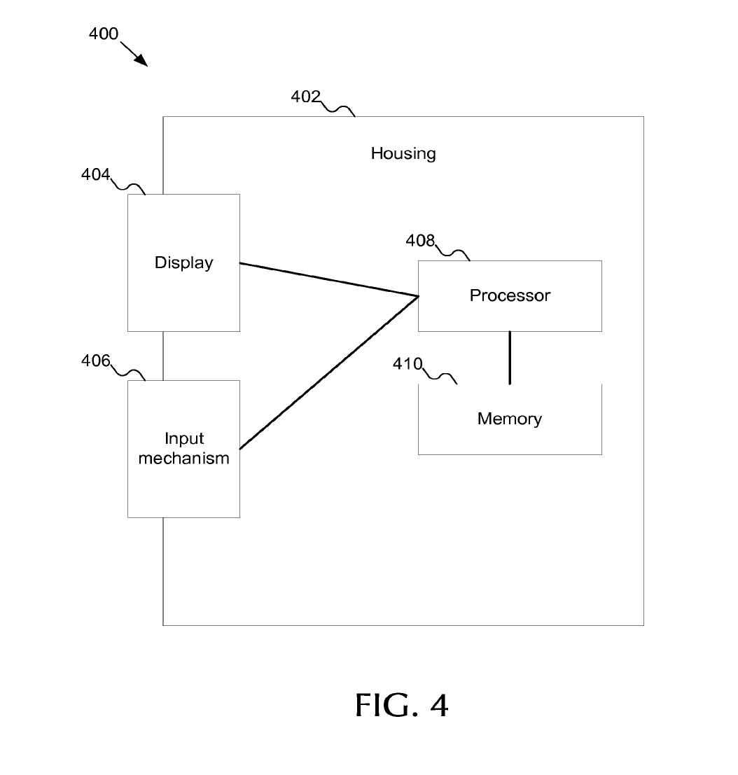

FIG. 4 illustrates an example of a system 400 in which certain aspects of the disclosed technology may be implemented. The system 400 may include, but is not limited to, a computing device such as a laptop computer, a mobile device such as a handheld or tablet computer, or a communications device such as a smartphone. The system 400 includes a housing 402, a display 404 in association with the housing 402, an input mechanism 406 in association with the housing 402, a processor 408 within the housing 402, and a memory 410 within the housing 402. The input mechanism 406 may include a physical device, such as a keyboard, or a virtual device, such as a virtual keypad implemented within a touchscreen. The processor 408 may perform virtually any of or any combination of the various operations described above. The memory 410 may store information resulting from processing performed by the processor 408.

Embodiments of the disclosed technology may be incorporated in various types of architectures. For example, certain embodiments may be implemented as any of or a combination of the following: one or more microchips of integrated circuits interconnected using a motherboard, a graphics and/or video processor, a multicore processor, hardwired logic, software stored by a memory device and executed by a microprocessor, firmware, an application specific integrated circuit (ASIC), and/or a field programmable gate array (FPGA). The term “logic” as used herein may include, by way of example, software, hardware, or any combination thereof.

Although specific embodiments have been illustrated and described herein, it will be appreciated by those of ordinary skill in the art that a wide variety of alternate and/or equivalent implementations may be substituted for the specific embodiments shown and described without departing from the scope of the embodiments of the disclosed technology. This application is intended to cover any adaptations or variations of the embodiments illustrated and described herein. Therefore, it is manifestly intended that embodiments of the disclosed technology be limited only by the following claims and equivalents thereof.

What is claimed is:

1. A method, comprising:
a user's mobile device determining location information corresponding to the mobile device within an establishment;
the mobile device communicating with a smart shopping infrastructure, wherein the communicating comprises providing the smart shopping infrastructure with the location information;
cross-referencing the location information with inventory information to determine a first location within the establishment where the mobile device is currently situated; and
the smart shopping infrastructure providing the mobile device with at least one smart shopping service based at least in part on the cross-referencing.

2. The method of claim 1, wherein the establishment is a store.

3. The method of claim 1, wherein the smart shopping infrastructure performs the cross-referencing.

4. The method of claim 1, wherein the user's mobile device performs the cross-referencing.

5. The method of claim 1, wherein the determining comprises the mobile device using visible light communication (VLC).

6. The method of claim 1, wherein the at least one smart shopping service comprises a targeted content service configured to cause the mobile device to display at least one of a group consisting of: an advertisement, general information pertaining to at least one product al the first location, and a promotion corresponding to at least one product at the first location.

7. The method of claim 1, wherein the at least one smart shopping service comprises an indoor navigation service configured to cause the mobile device to direct the user to a second location within the establishment.

8. The method of claim 1, wherein the at least one smart shopping service comprises an inventory supply service configured to cause the mobile device to provide the user with information pertaining to stocking, re-stocking, or both as pertaining to at least one product at the first location.

9. The method of claim 1, wherein the at least one smart shopping service comprises shopper data analytics configured to determine an optimal placement for a product based at least in part on user-specific information.

10. The method of claim 1, wherein the at least one smart shopping service is further based on a personal profile corresponding to the user.

11. The method of claim 10, further comprising updating the personal profile based on monitored actions by the user within the establishment.

12. The method of claim 10, further comprising one or both of the mobile device and the smart shopping infrastructure storing the personal profile.

13. The method of claim 1, further comprising a digital sign displaying information based at least in part on the cross-referencing.

14. The method of claim 10, further comprising a digital sign displaying information based at least in part on the cross-referencing and the personal profile.

15. A system, comprising:
a plurality of visible light communication (VLC) devices within an establishment;
a mobile device configured to be used by a user within the establishment; and
a smart shopping server configured to provide at least one smart shopping service to the mobile device based at least in part on location information based on communication with at least some of the plurality of VLC devices.

16. The apparatus of claim 15, wherein the smart shopping server is further configured to store a personal profile corresponding to the user.

17. The apparatus of claim 16, wherein the at least one smart shopping service is further based on the personal profile.

18. The apparatus of claim 16, wherein the mobile device is further configured to cause the smart shopping server to update the personal profile based on monitored activity of the user within the establishment.

19. The apparatus of claim 15, wherein the establishment comprises a store.

20. The apparatus of claim 15, wherein the mobile device comprises one of a group consisting of: a handheld computing device, a tablet computing device, and a smartphone.

21. A mobile device, comprising:
a housing;
a display in connection with the housing; and
a processor configured to:
determine a location of the mobile device based on at least one location beacon received by the mobile device from a visible light communication (VLC) source;
communicate with a smart shopping infrastructure; and
cause the display to present content to the user based at least in part on the location and the communication with the smart shopping infrastructure.

22. The mobile device of claim 21, further comprising a memory configured to store a user profile, wherein the content presented to the user is further based on the user profile.

23. The mobile device of claim 21, further comprising an input mechanism configured to enable the user to provide the mobile device with user interaction information, wherein the content presented to the user is further based on the user interaction information.

24. A non-transitory computer-readable medium storing instructions that, when executed by a processor, cause the processor to:
determine a location of a mobile device based on at least one location beacon received by the mobile device from a visible light communication (VLC) source;
communicate with a smart shopping infrastructure; and
cause a display of the mobile device to present content to a user of the mobile device based at least in part on the location and the communication with the smart shopping infrastructure.

25. The non-transitory computer-readable medium of claim 24, wherein the content is further based on a user profile.

26. The non-transitory computer-readable medium of claim 25, wherein the instructions further cause the processor to update the user profile.
